(19) United States
(12) Patent Application Publication
(10) Pub. No.: US 2012/0050754 A1
(43) Pub. Date: Mar. 1, 2012

(54) LAST PAGE SAVER

(76) Inventors: John R. Fredlund, Rochester, NY (US); Frank Razavi, Fairport, NY (US); Robert P. Cloutier, Canandaigua, NY (US); Guy E. Light, Webster, NY (US)

(21) Appl. No.: 12/868,122

(22) Filed: Aug. 25, 2010

(51) Int. Cl. H04N 1/60

(52) U.S. Cl. 358/1.9

(57) ABSTRACT

A computer implemented method of rendering a print job comprises determining that a last page of a print job comprises insignificant text or no text. Modifying the print job in response to this determination is then performed, which can include deleting the last page, displaying a user interface for presenting options for implementing the step of modifying the print job, or reducing a margin of the text on the last page of the print job.

### FIELD OF THE INVENTION

The present invention is directed to a printing method and apparatus for selectively printing a last page of a multi-page document. In particular, if a last page of a multi-page document does not contain, or contains a sufficiently small amount of, printed matter of interest, the last page can selectively not be printed or a small amount of material can be moved onto a previous page for printing.

### BACKGROUND OF THE INVENTION

When printing documents, it is frustrating and wasteful to print sheets of paper with a minor amount of coverage, or with unnecessary coverage. This problem has been identified by Cudd, in U.S. Application No. 2007/0273895 and also by Brown, in U.S. Pat. No. 6,688,786.

Cudd teaches a method where scaling is used to avoid a condition where minimal text is printed on the last page. The user must select a custom printing mode in a particular application to obtain the benefit of this scaling. The custom printing mode is implemented by supplementary code that is provided for the application. In this custom printing mode, Cudd detects a predetermined threshold for which a page is deemed potentially “not worth printing.” The user is prompted for a decision on whether or not to use scaling for the print job. If scaling is selected, the small amount of text on the last page is moved onto the previous page using space created by the scaling operation. The threshold taught by Cudd is a vertical limit. When text placement exceeds this predefined limit, a specialized preview is invoked.

Brown also teaches a method for suppressing printing of nearly-blank pages. Brown teaches that in many cases, there is header and footer text that may satisfy the requirement of Cudd, but still enable printing of pages of limited value. Brown identifies a window boundary for determining nearly-blank pages, thus eliminating the header and footer from the analysis. Additionally, “a page with a small number of dots to be marked within the window boundary could also be designated a nearly-blank page.”

What is needed is a method of inhibiting or reformatting not only nearly blank pages, but also those pages that have marking coverage that exceeds the thresholds of Cudd and Brown, yet still carry little in the way of desired information.

### SUMMARY OF THE INVENTION

A preferred embodiment of the present invention comprises a computer implemented method of receiving a print job for a printer, formatting the print job, wherein the formatted print job includes a number of pages comprising text, and a last page of the text includes an image. A minimal amount of text on the last page is detected and image data for the image is detected. The last page is reformatted, where formatting, format, formatted, reformatting, reformatted, modified, and modifying are taken to mean any of various steps including deleting a page or the last page from the print job, deleting portions of the last page such as text or images, printing only portions of images or text, setting new margins or font size, and any other step of page or page data manipulation. Reformatting preferably comprises deleting the image from the last page before printing the last page. Reformatting can also include decreasing a margin on at least one side of the text to be printed on the last page, before printing the last page.

Another preferred embodiment of the present invention comprises a computer implemented method of receiving a print job and formatting the print job which includes printable pages comprising text and a last page that comprises an image. If the last page also includes a blank space, it is detected and the last page is reformatted so that the last page is not printed. If the last page also includes text, then only the text is printed on the last page without the image. A user interface can be displayed on the computer system for the user to selectively control printing or not printing the last page.

Another preferred embodiment of the present invention comprises a computer implemented method of rendering a print job comprising a determination that a last page of a print job comprises insignificant text or no text. Insignificance includes a minimal amount or a minimal importance of the text. Terms such as “comments,” “footnotes,” “cites,” “bibliography,” “sponsored,” or other terms, words, or headings may indicate insignificant text. A user selected term or terms can be stored and the present method implemented with respect to the user selected word for indicating to the computer system that the last page text is insignificant. Modifying the print job in response to this determination is then performed, which can include deleting the last page, displaying a user interface for presenting options for implementing the step of modifying the print job, deleting an image, deleting an image but not text on the last page of the print job, or reducing a margin of the text on the last page of the print job.

These, and other, aspects and objects of the present invention will be better appreciated and understood when considered in conjunction with the following description and the accompanying drawings. It should be understood, however, that the following description, while indicating preferred embodiments of the present invention and numerous specific details thereof, is given by way of illustration and not of limitation. For example, the summary descriptions above are not meant to describe individual separate embodiments whose elements are not interchangeable. In fact, many of the elements described as related to a particular embodiment can be used together with, and possibly interchanged with, elements of other described embodiments. Many changes and modifications may be made within the scope of the present invention without departing from the spirit thereof, and the invention includes all such modifications. The figures below are intended to be drawn neither to any precise scale with respect to relative size, angular relationship, or relative position nor to any combinational relationship with respect to interchangeability, substitution, or representation of an actual implementation.

### BRIEF DESCRIPTION OF THE DRAWINGS

FIG. 1 illustrates an example last page that may be selected not to print or to be modified.

FIG. 2 illustrates a system for implementing an embodiment of the present invention.

FIG. 2A illustrates a flow chart of an algorithm for implementing an embodiment of the present invention.

FIG. 3 illustrates an example last page that may be selected not to print or to be modified.

FIG. 4 illustrates an example last page that may be selected not to print or to be modified.

FIG. 5 illustrates an example last page with images automatically removed.

FIG. 6 illustrates an example last page that may be selected not to print or to be modified.

FIG. 7 illustrates an example last page that may be selected not to print or to be modified.

FIG. 8 illustrates the condition where the vertical dimension of text is less than the vertical dimension of an image.

### DETAILED DESCRIPTION OF THE INVENTION

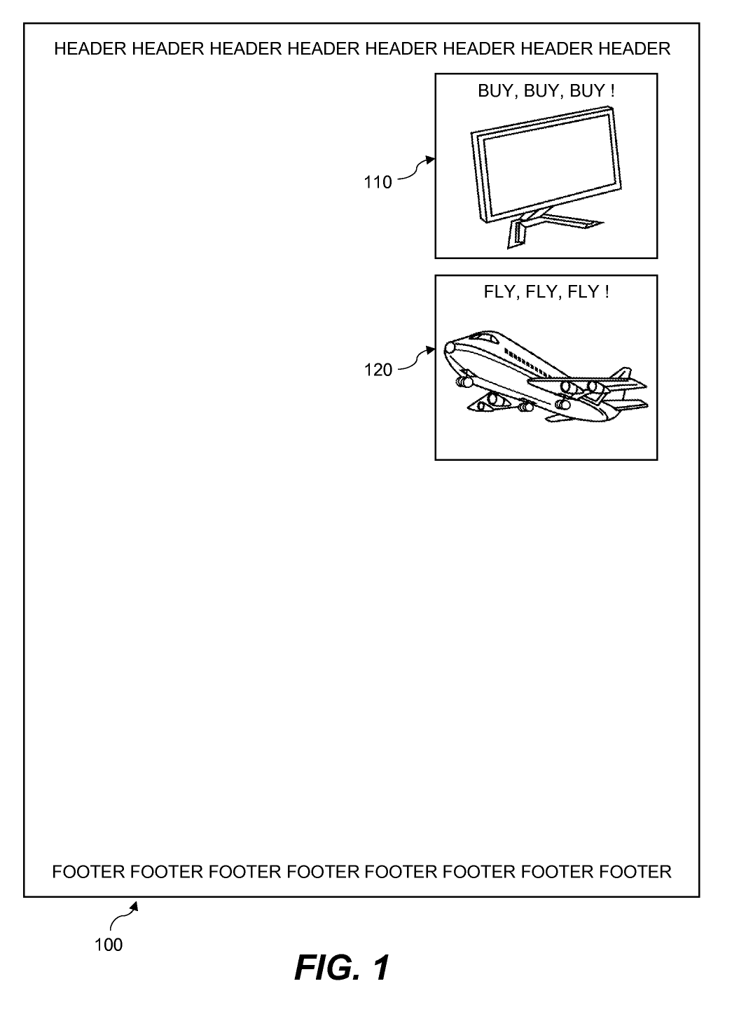

FIG. 1 illustrates a common situation for last page 100 of a print job generated by a web browser, which contains a web page, sent to a printer. Previous pages (not shown) contain the information of value to the user. Advertisements 110 and 120 are included in the print job and have extended the print job such that last page 100 is to be printed.

In a preferred embodiment, the condition where the advertisements extend onto additional last page 100 is detected. The detection takes place in the driver for the printer. This provides utility in that special code need not be incorporated into the application software, avoiding the need to download add-ons for many applications. Additionally, the manner in which detected conditions are presented to the user is made uniform for the printer.

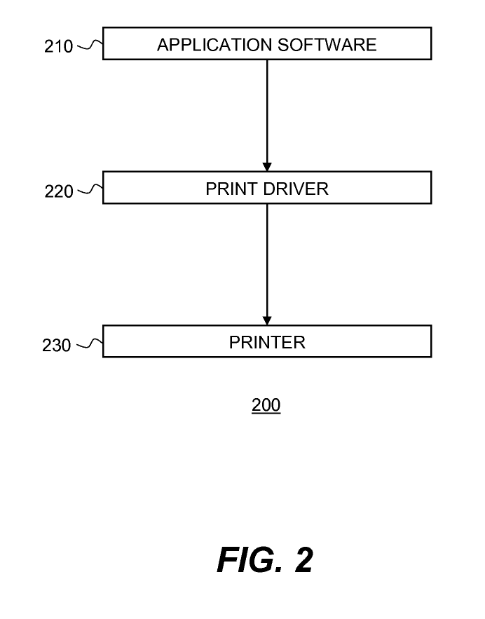

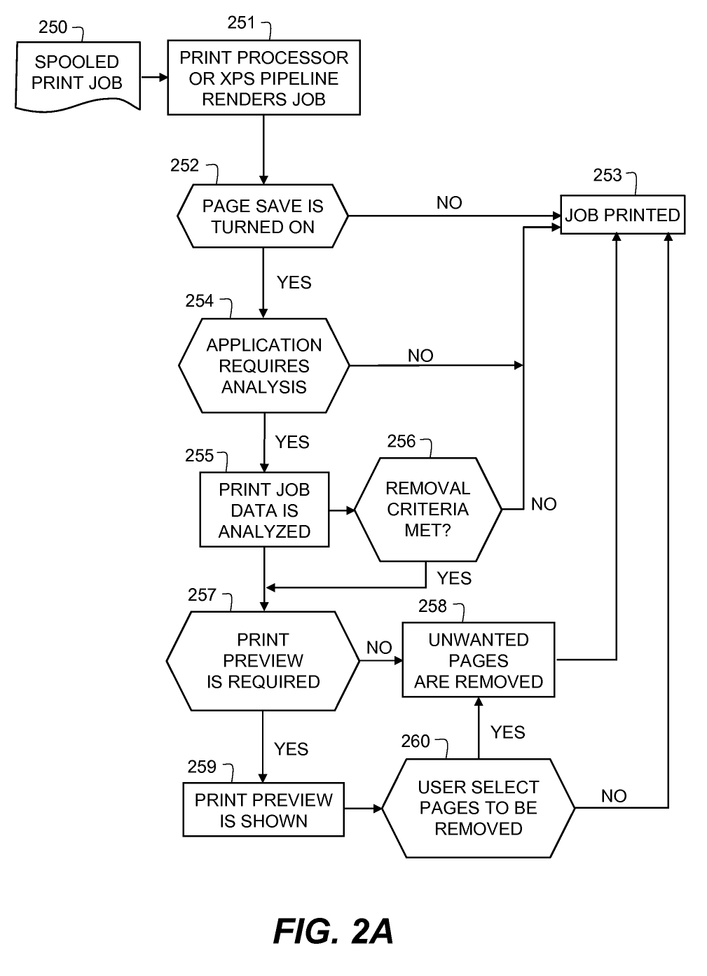

The condition illustrated by FIG. 1 can be detected in a number of ways. If the advertisements are provided as images, print driver 220 of data processing system 200 shown in FIG. 2 can analyze the incoming data for one of a number of removal criteria. For example, print driver 220 can analyze the incoming data from application software 210 and, on the basis of data types such as JPEG or TIFF files, detect a removal criterion that other than the header and footer, last page 100 contains only images. In this case print driver 220 can generate a preview to appear on the user's document display together with a user interface for allowing the user to make a decision on whether or not last page 100 should be printed. Alternatively, print driver can automatically decide not to print last page 100 and send the modified print job to printer 230.

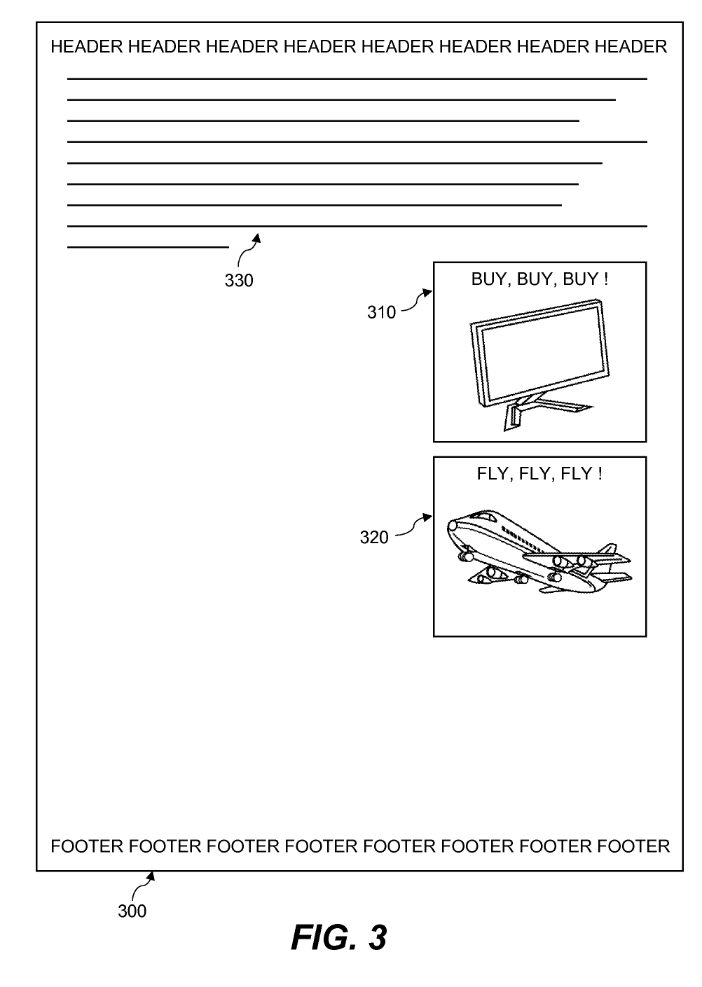

Note that a decision to generate a preview, or not to print, can also be made for another removal criterion where a predefined small amount of text is detected along with the images as shown in FIG. 3. Here small amount of text 330 and advertisements 310 and 320 are presented for printing on last page 300. Text 330 may be of value to the user while advertisements 310 and 320 may not. In this case, a preview may be provided to allow the user to determine if the text is of value. If text 330 is not of value, page 300 need not be printed, and the user can indicate this by selecting appropriate controls on the user interface (not shown) provided by the print driver 220. Alternatively, if text 330 is of value but images 310 and 320 are not, print driver 220 can print only text 330 when directed to do so by the user in an optional feature of the user interface.

Print driver may also analyze the coverage of last page 100. In another removal criterion such as shown in FIG. 1, although the area to be printed extends down page 100 close to half its length, there is no coverage on the left side of last page 100. Print driver 220 can detect this condition and generate a preview or automatically not print last page 100 in response to this detection. The detected condition may include off center coverage or incomplete coverage. It is a triggering condition that a page is of little value to the user when coverage of this type is detected.

FIG. 2A is a flow chart showing a preferred embodiment of the invention as implemented in the printer driver of FIG. 2. After the print job is spooled, or received, at step 250, the print processor or XPS Pipeline renders, or formats, the print job in step 251. If the page saving function is determined to be turned off in step 252, the job is printed in step 253. If the page saving function is turned on, a determination is made in step 254 concerning whether or not the print job comes from an application that needs the last page saving function enabled. In particular, the invention provides benefit when printing from applications such as web browsers such as Mozilla Firefox, for example, where it is not obvious that a page of little use will be printed, but will have very limited benefit when printing from Adobe Photoshop, for example, where page boundaries are not usually an issue. In step 254, when the condition that the application requires analysis is satisfied, print job data is analyzed in step 255. Here the content of each page as rendered is compared to criteria for removal, such as minimal text with images, step 256. Minimal text is the condition where text is not filling the page, or not filling some predetermined percentage or vertical dimension of the page. If the removal criteria is not met the job is printed at step 253. If the removal criteria is met, the print driver determines if preview is required in step 257. Previewing may be required for a number of reasons including ambiguous conditions or user preferences that specify that preview is desired when removal criteria is met. If preview is not required, the unwanted page or pages are removed from the print job in step 258 and then the job is printed at step 253. If preview is required, in step 259 a print preview is shown and the user selects pages that are to be removed in step 260, and the job is printed in step 253. The preview shows pages that have been tagged for removal and allows the user to override the tagging, allow the tagged pages to not be printed as indicated, or to add more pages for removal.

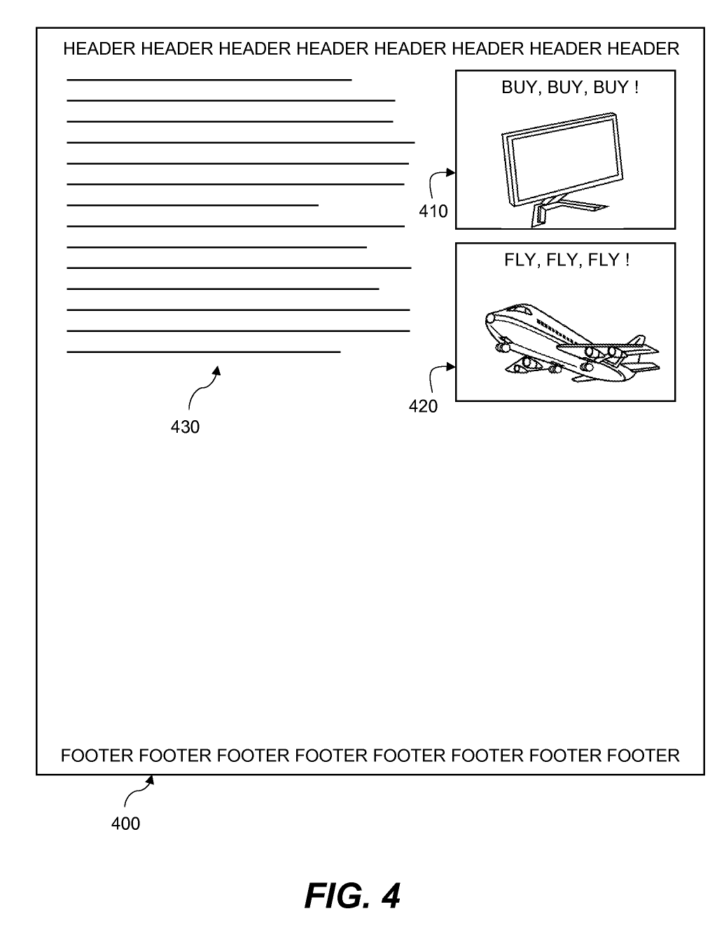

FIG. 4 shows a condition where both text and images are present on last page 400. In this case, text 430 and advertisement 410 both occupy the same vertical dimension at the top of the page. Advertisement 420 extends vertically well beyond text 430. This detected removal criterion where images extend beyond text may trigger a preview (user interface) or direct print driver 220 to automatically not print page 400.

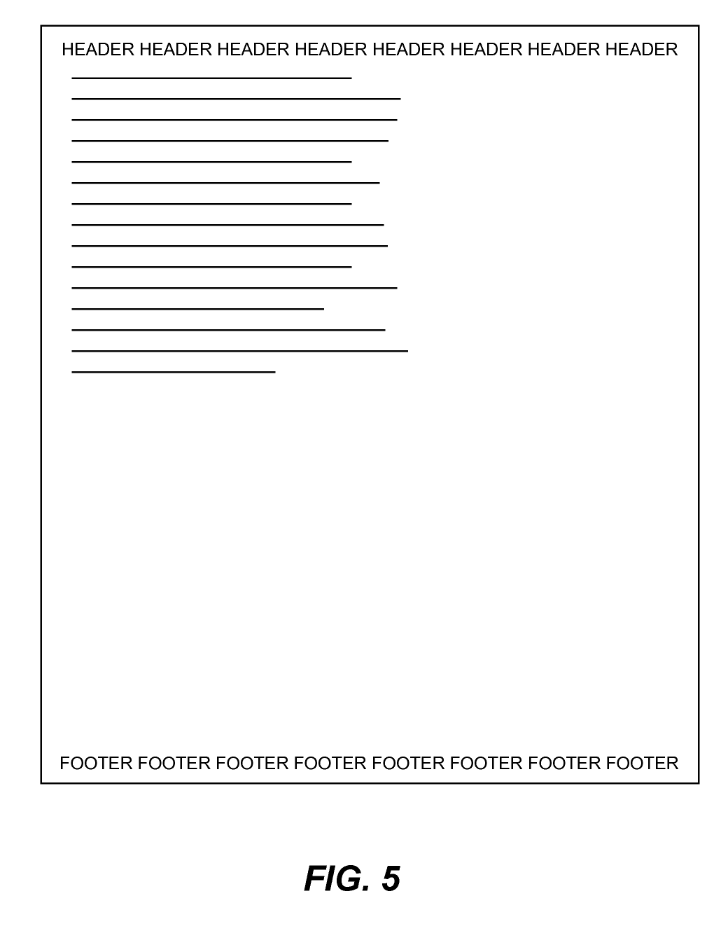

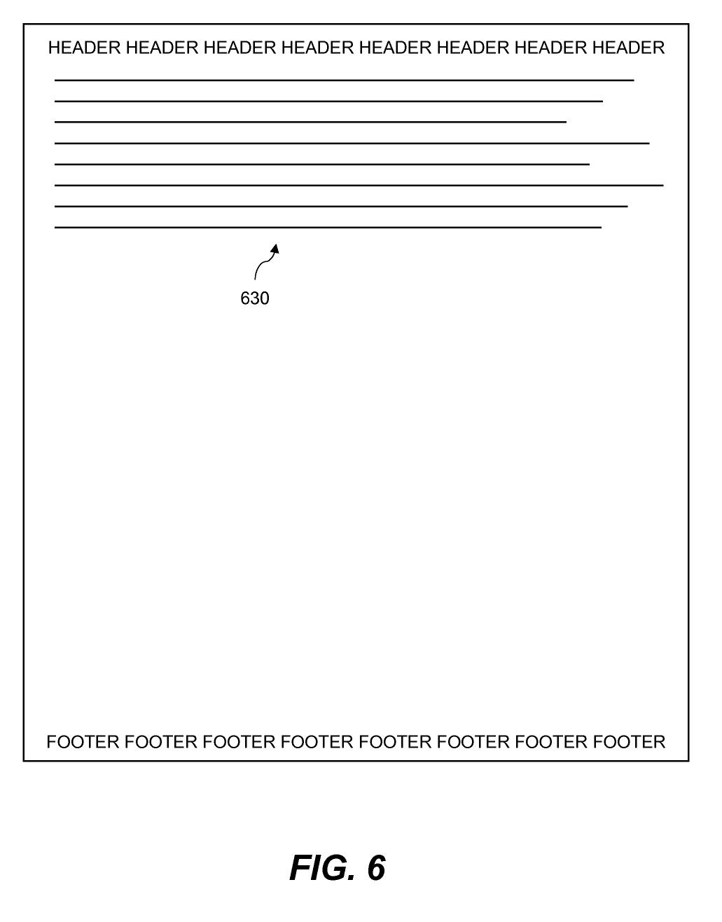

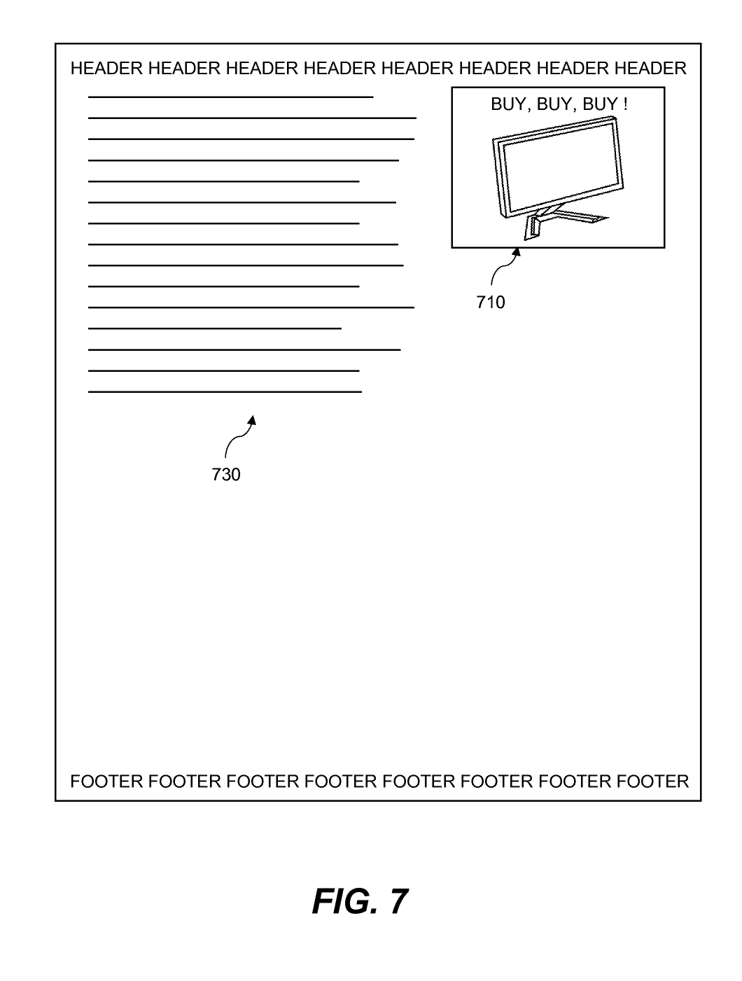

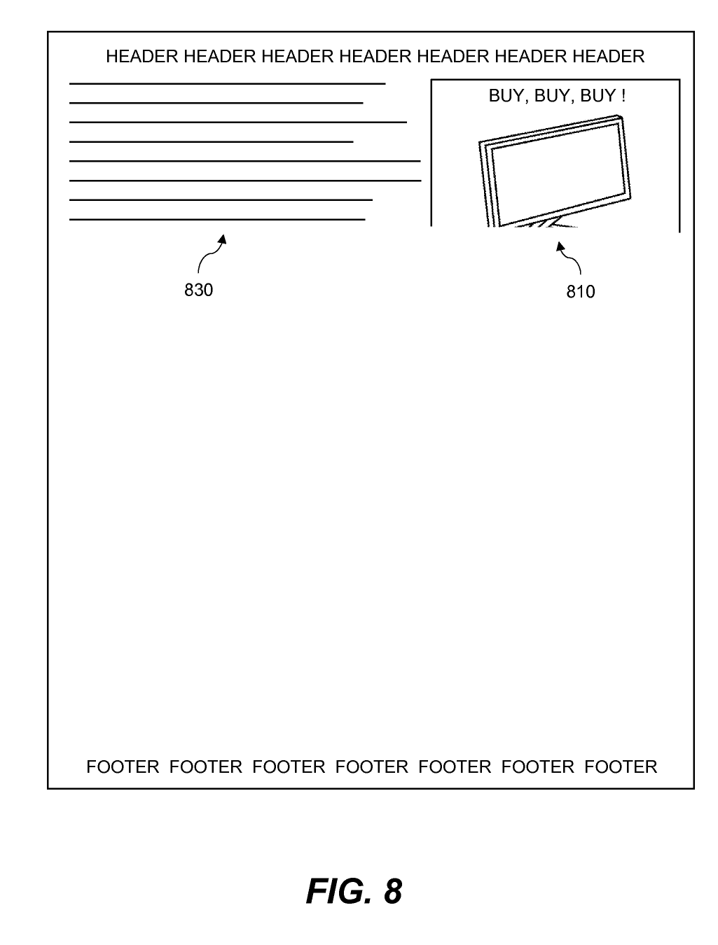

Alternatively, this detected condition may provide alternative previews with text-only printing or automatically printed pages where images have been automatically removed from the print job, such as illustrated in FIG. 5 and in FIG. 6. Such steps are referred to herein as re-rendering or reformatting. FIG. 6 illustrates a reformatting strategy where images (from FIG. 4) are removed and the text portion from FIG. 4 is reformatted 630 to fill the horizontal dimension of the page by decreasing page margins on left, right, or both sides of the text. FIG. 7 illustrates yet another option of handling the detected condition of FIG. 4. Here the reformatting comprises stopping the print job at the point after text 730 has been printed, and only image 710 is printed since it lies within the vertical dimension of the text 730. FIG. 8 illustrates the condition where the vertical dimension of text 830 is less than the vertical dimension of image 810, and the reformatting comprises printing only the portion of image 810 that falls substantially within the vertical dimension of text 830.

Print driver 220 may also use different triggers for different application software 210. For example, if application software 210 is a web browser application such as Mozilla Firefox, then the image data for printing last page 100, 300, or 400 presented to print driver 220 are likely images that are advertisements. In these cases, the images are likely to be advertisements that the user would prefer not to print, and it is appropriate that print driver 220 generate a preview or not print the page in question. However, if application software 210 is a word processing application such as Microsoft Word, then the image data for printing last page 100, 300, or 400 presented to print driver 220 are likely images that are not advertisements, and the user would not necessarily benefit from a preview (user interface) or from automatically not printing the last page. Preferred print responses in circumstances such as these can be set through the print driver 220 by the user. Another option that can be set according to the type of application is “don't print images.” In many cases, only the text conveys the useful information that the user desires.

Print driver 220 may also detect conditions that are indicative of diminishing print value. One such condition is the occurrence of the word “comment” in the text. Often, this term is used to denote that reader comments are provided below. These comments may not be considered worthwhile to print when printing a web article. The text for the trigger condition can be stored by the user in a “preferences” section in the user interface for printer driver 220.

Step 255 of FIG. 2A, where print job data is analyzed, is now described in greater detail for the purpose of explanation and not by way of limitation. At this step, the print job has been rendered. A bitmap has been created that corresponds to the positions of the marks that will appear on the paper if the page is printed. This bitmap is analyzed for detecting the criteria that are indicative of a page that is unlikely to provide much useful information. There are many criteria which can be selected for detection in the print driver.

The criteria necessary to prevent the page shown in FIG. 3 from being printed is image-only coverage of less than full page width. This page is undesirable because there are advertisements that extend beyond the text. These images convey little or no desired information, and are wasteful of ink.

The bitmap is analyzed row by row from top to bottom of the page, where rows are horizontal sequences of contiguous spaces. The analysis of the rows at the top of the page, which contain the header, show intermittent coverage in a single color which is characteristic of text. This condition may not meet the removal criteria. Further down the page, the analysis will show that the entire width of the page has similar intermittent coverage in a single color that is characteristic of text. This also does not meet the criteria for removal, since this condition is indicative of text that may be of value. A third condition is detected where the text rendered for the page has ended. Here, there is a large space with no marking on the left side of the page, and the right side coverage is full, or nearly full, with coverage in many colors. This detected condition meets the removal criteria, and a print preview is generated. The analysis indicates that there are large areas of unprinted space adjacent to an image, regardless of the position of the image.

The detected criteria necessary to prevent the page shown in FIG. 4 from being printed is that of less than full width coverage. This page is undesirable because there are image advertisements that extend beyond the text. These images convey little or no desired information, and are wasteful of ink.

A limitation to the criteria can be provided that requires that the first line that meets the criteria for removal is printed. By limiting the criteria in this fashion, partial lines of text that are positioned at the end of text of value will be printed even though there is blank space on the partial line.

Once the criteria have been detected, actions may be taken to remediate the situation where unwanted printing may occur. In addition to generating a preview that allows the user to determine if a particular page is to be printed or not, the print driver may also provide automatically executed options for printing.

The invention has been described in detail with particular reference to certain preferred embodiments thereof, but it will be understood that variations and modifications can be effected within the spirit and scope of the invention.

### PARTS LIST

100 page
110 image
120 image
210 application
220 driver
230 printer
250 job
251 step
252 step
253 step
254 step
255 step
256 step
257 step
258 step
259 step
260 step
300 page
310 image
320 image
330 text
400 page
410 image
420 image
430 text
630 text
710 image
730 text
810 image
830 text

1. A computer implemented method comprising:
receiving a print job for a printer;
formatting the print job, the formatted print job including a plurality of pages comprising text, wherein a last page of the plurality of pages comprises an image;
detecting a condition comprising minimal amount of text to be printed on the last page and image data for the image; and
reformatting the last page of the formatted print job in response to the step of detecting.

2. The method of claim 1, further comprising the step of detecting that a web browser application generated the print job.

3. The method of claim 2, wherein the step of reformatting comprises deleting the image from the last page before printing the last page.

4. The method of claim 3, wherein the step of reformatting further comprises decreasing a margin on at least one side of the text to be printed on the last page before printing the last page.

5. The method of claim 1, wherein the step of reformatting comprises determining a vertical position of a last line of text to be printed on the last page and printing only those portions of the image that do not extend below the vertical position.

6. The method of claim 1, further comprising the step of determining a type of application that generated the print job and wherein the step of reformatting comprises including the image in the print job based on the step of determining the type of application that generated the print job.

7. The method of claim 6, wherein the step of determining the type of application that generated the print job includes determining that a word processor generated the print job.

8. A computer implemented method comprising:
receiving a print job for a printer;
formatting the print job, the formatted print job including a plurality of pages comprising text, wherein a last page of the plurality of pages comprises an image;
detecting both a blank space on the last page and the image; and
reformatting the last page of the formatted print job in response to the step of detecting.

9. The method of claim 8, wherein the step of reformatting comprises printing the print job without the last page.

10. The method of claim 8, wherein the step of reformatting comprises generating a user interface for selectively controlling printing or not printing the last page.

11. The method of claim 8, wherein the step of detecting comprises detecting a small amount of text on the last page and the step of reformatting comprises printing the small amount of text on the last page but not the image.

12. The method of claim 8, wherein the step of detecting comprises detecting a small amount of text on the last page and the step of reformatting comprises determining a vertical position of a last line of the small amount of text on the last page and printing only those portions of the image that do not extend below the vertical position.

13. The method of claim 8, further comprising the steps of determining that a word processor generated the print job and printing the print job entirely.

14. A computer implemented method of rendering a print job comprising:
determining an occurrence of a preselected word in the text of the print job; and
modifying the print job in response to the step of determining.

15. The method of claim 14 wherein the step of modifying includes deleting a last page of the print job.

16. The method of claim 14 further comprising the step of displaying a user interface for presenting options for implementing the step of modifying the print job.

17. The method of claim 14 further comprising the step of determining that the last page of the print job comprises an image and the step of modifying the print job comprises deleting the image.

18. The method of claim 16 wherein the options for implementing the step of modifying the print job include deleting an image and deleting a last page of the print job.
